(19) United States
(12) Patent Application Publication
(10) Pub. No.: US 2026/0339339 A1
(43) Pub. Date: Oct. 29, 2026

(54) METHOD FOR CONTROLLING THE TRAJECTORY OF AN AIRCRAFT

(71) Applicant: SAFRAN ELECTRONICS & DEFENSE, PARIS (FR)

(72) Inventors: Dominique MALTESE, MOISSY CRAMAYEL (FR); Julien FARJON, MOISSY CRAMAYEL (FR)

(21) Appl. No.: 19/111,606

(22) PCT Filed: Aug. 30, 2023
(86) PCT No.: PCT/FR2023/051316

§ 371 Date: Mar. 13, 2025

(30) Foreign Application Priority Data
Sep. 16, 2022 (FR) FR2209378

(51) Int. Cl. G05D 1/633; G05D 1/243; G05D 101/15; G05D 109/20; G05D 111/10

(52) U.S. Cl. CPC G05D 1/633; G05D 1/2437; G05D 2101/15; G05D 2109/20; G05D 2111/10

(57) ABSTRACT

A method for controlling an aircraft includes at least one camera and a guidance system configured to indicate a trajectory to the aircraft, the method being implemented by a computer and including acquiring a distance between the aircraft and an obstacle on the trajectory of the aircraft and a time before the aircraft collides with the obstacle from images of the obstacle obtained by the camera; estimating at least one radial speed of the obstacle using an extended Kalman filter taking as input the distance and the time before the aircraft collides with the obstacle; and modifying the trajectory of the aircraft by the guidance system, according to the estimated radial speed value of the obstacle and the distance between the aircraft and the obstacle, so as to avoid a collision of the aircraft with the obstacle.

### TECHNICAL FIELD OF THE INVENTION

The technical field of the invention is that of the navigation of flying objects and in particular aircraft.

The present invention relates to a method for controlling trajectory of an aircraft, and in particular a method for controlling trajectory by estimating radial speed based on an extended Kalman filter with, as an input measurement, a distance between the aircraft and the obstacle and a “time-to-collision” between the aircraft and the obstacle.

### TECHNOLOGICAL BACKGROUND OF THE INVENTION

In aircraft navigation, the “detect and avoid” function is performed based on distance measurements between the aircraft and an obstacle to be avoided on the aircraft trajectory.

This function makes it possible to perceive or “detect” a future air traffic conflict that could lead to a collision and to take appropriate measures to “avoid” the occurrence of said conflict.

Active systems exist, such as Millimetre-Wave Radar (MMW radar) or laser radar (LADAR). These active systems are bulky and expensive, which is not desirable for use in light aircraft such as drones, or in aircraft for which it is sought to reduce mass, such as passenger aircraft.

Passive obstacle detection systems have therefore been developed, using for example EO/IR (Electro-Optical/Infra-Red) sensors. Among passive systems, some of them make it possible to obtain a distance between the aircraft and the obstacle, while others make it possible to obtain a ‘time-to-collision’ between the aircraft and the obstacle. “Time-To-Collision”, also abbreviated “TTC”, is also known as “Time-To-Go”, abbreviated “TTG”, and “Time-To-Arrival”, abbreviated “TTA”.

“Time-to-collision” is defined as the time remaining before a collision between the aircraft and the obstacle occurs if both their trajectories and speeds are not modified.

The distance can be obtained, for example, by:
estimating by artificial intelligence using image analysis, as described in FR3094081A1 “Procédé d′estimation passive du temps avant collision pour un aéronef ou de tout objet volant pouvant être guidé, procédé de navigation associe “, wherein the time-to-collision is estimated by analysing images from an on-board camera, analysing being performed by a neural network trained to estimate the time-to-collision from the size of the obstacle in pixels. The distance can be estimated for each image. A drawback of this technique is that the time-to-collision and the distance between the aircraft and the obstacle obtained are inaccurate.
passive ranging. For example, an “azimetry”-type method can be used, as set forth in [“Utilization of modified polar coordinates for bearings-only tracking”—V. J. AIDALA, S. E. HAMMEL, IEEE, 2007, pp. 741-752, doi: 10.1109/9780470544198.ch74]. Azimetry reconstructs the trajectory of the obstacle using azimuth measurements performed by the aircraft.
using RPEKF (Range-Parameterised Extended Kalman Filter) filter banks initialised on a priori distances, as set forth in [“Recursive Bayesian Estimation—Bearings-only Applications”—R. KARLSSON, F. GUSTAFSSON, IEEE, November 2005, DOI: 10.1049/ip-rsn: 20045073]. The RPEKF can give good results if the distance is observable, because the obstacle is tracked only in angular terms, and if the metadata are of very good quality, because it is then desired to obtain three-dimensional information by having only two pieces of angular information and observing the trajectory of the obstacle projected into the image plane of the optronic sensor.

Radial speed accuracy is an important system requirement for integrating an aircraft into air traffic. To have good radial speed accuracy, i.e. sufficient radial speed accuracy to have an effective “detect and avoid” function in air traffic, it must be possible to extract the distance and time-to-collision with sufficient quality. Time-to-collision is generally calculated by observing:
either the variation in the signal emitted by the obstacle, with the signal increasing overall as the target gets closer (for example in the infrared bands),
or the variation in the apparent size of the obstacle between images, for example in the number of pixels, which increases as the target gets closer.

Knowing the time-to-collision, it is possible to deduce the radial speed, but with such accuracy that it requires an increase in distance performance to obtain a good quality radial speed.

The radial speed error requirement is the most critical because if this is determined via distance estimation, then the distance error has to be reduced to levels that may be difficult for passive EO/IR technologies to achieve.

There is therefore a need to obtain, in an aircraft implementing a passive measurement system, better estimation of the radial speed of an obstacle than the state of the art.

### SUMMARY OF THE INVENTION

The invention provides a solution to the problems previously discussed, by enabling better estimation of radial speed without the need for better distance measurements.

One aspect of the invention thus relates to a method for controlling an aircraft comprising at least one camera and a guidance system configured to indicate a trajectory to the aircraft, the method being computer-implemented and being characterised in that it comprises the following steps of:
Acquiring a distance between the aircraft and an obstacle on the trajectory of the aircraft and a time-to-collision of the aircraft with the obstacle from images of the obstacle obtained by the camera,
Estimating at least one radial speed of the obstacle using an extended Kalman filter taking as an input said distance and said time-to-collision of the aircraft with the obstacle,
Modifying the trajectory of the aircraft by the guidance system, as a function of the radial speed value estimated of the obstacle and the distance between the aircraft and the obstacle so as to avoid collision of the aircraft with the obstacle.

The present invention makes direct use of the time-to-collision of the aircraft with the obstacle as well as the distance between the obstacle and the aircraft to obtain, via an Extended Kalman Filter (abbreviated as EKF), a more accurate radial speed. This will decrease the distance restriction that would otherwise be necessary if the radial speed were obtained by another means, as in prior art. In addition, the invention makes it possible to use an optronic system by making it more relevant to provide a “detect and avoid” function by virtue of obtaining a radial speed with good performance, i.e. an estimated radial speed that is closer to the actual radial speed of the obstacle than in prior art. Finally, by virtue of the invention, the decision to modify the trajectory is more reliable and/or more accurate by taking the radial speed into account. The reliability and/or accuracy of the invention is of course all the greater when the radial speed is accurate. Typically, radial speed can be measured by radar using Doppler filtering. Its variation can be observed earlier than the variation in distance that will occur when the target manoeuvres, which is a good indicator of the start of the manoeuvre.

Further to the characteristics just discussed in the preceding paragraph, the method according to one aspect of the invention may have one or more additional characteristics from among the following, considered individually or according to any technically possible combination:
the extended Kalman filter comprises a measurement vector and a state vector, the measurement vector comprising the distance between the aircraft and the obstacle and the inverse of the time-to-collision of the aircraft with the obstacle, the state vector comprising the distance between the aircraft and the obstacle and the radial speed of the obstacle relative to the aircraft.
the distance between the aircraft and the obstacle is obtained by an automatic learning method based on image analysis, the images having been obtained by a camera on board the aircraft.
the time-to-collision of the aircraft with the obstacle is obtained by an automatic learning method based on image analysis, the images having been obtained by a camera on board the aircraft.
the radial speed is obtained by using a plurality of extended Kalman filters, each extended Kalman filter of the plurality of extended Kalman filters modelling one kinematic regime of the obstacle from a plurality of kinematic regimes of the obstacle, the kinematic regime modelled by each extended Kalman filter of the plurality of extended Kalman filters being different from the kinematic regime modelled by the other extended Kalman filters of the plurality of extended Kalman filters.
each extended Kalman filter of the plurality of extended Kalman filters comprises a state vector representative of the kinematic regime modelled by the extended Kalman filter weighted by a probability of occurrence of the kinematic regime, the radial speed being included in a state vector being the barycentre of the state vectors of the extended Kalman filters of the plurality of extended Kalman filters.

Another aspect of the invention relates to an aircraft configured to implement the aircraft control method according to the invention, the aircraft comprising at least one camera and a guidance system configured to indicate a trajectory to the aircraft.

Another aspect of the invention relates to a computer program product comprising instructions which, when the program is executed by a computer, cause the same to implement the method for controlling an aircraft according to the invention.

Another aspect of the invention relates to a computer-readable recording medium comprising instructions which, when executed by a computer, cause the same to implement the method for controlling an aircraft according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a schematic representation of a system comprising an obstacle and an aircraft configured to estimate radial speed according to the invention,

FIG. 2 shows a schematic representation of a multi-model extended Kalman filter of one embodiment of the invention,

FIG. 3 shows a schematic representation of a method for controlling an aircraft according to the invention,

FIGS. 4A to 4C show graphical representations of results for an extended Kalman filter modelling a non-manoeuvring kinematic regime of obstacle O with distance D alone included in the measurement vector of the extended Kalman filter,

FIGS. 5A to 5C show graphical representations of results for an extended Kalman filter modelling a non-manoeuvring kinematic regime of obstacle O with distance D and time-to-collision TTC included in the measurement vector of the extended Kalman filter,

FIGS. 6A to 6D show graphical representations of results for a multi-model extended Kalman filter with distance D and time-to-collision TTC included in the measurement vector of the extended Kalman filter.

### DETAILED DESCRIPTION

Unless otherwise specified, a same element appearing in different figures has a single reference.

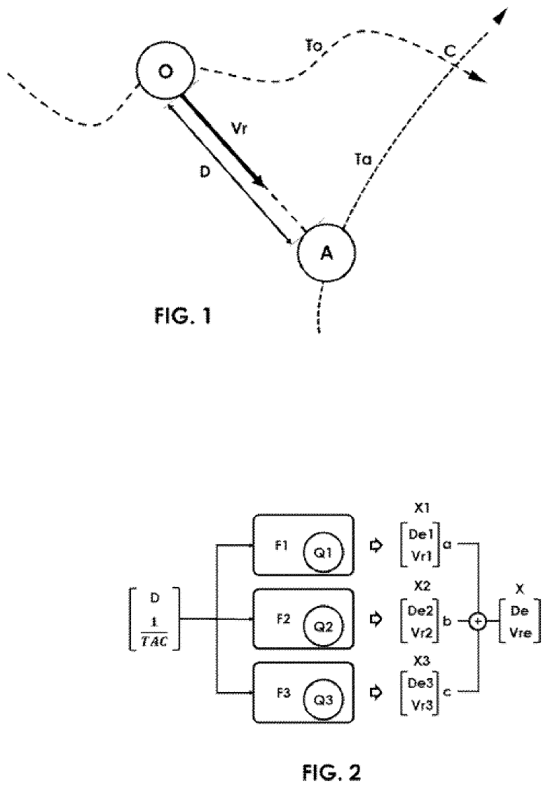

FIG. 1 shows a schematic representation of a system comprising an obstacle and an aircraft configured to implement the method of the invention. The obstacle O represented in FIG. 1 follows a trajectory To. The aircraft A represented in FIG. 1 follows a trajectory Ta. Preferentially, the trajectory Ta is determined by a guidance system on board the aircraft A, i.e. the guidance system determines a trajectory as a function of configuration information and/or a trajectory determination method, for example as a function of a point of departure, a point of arrival, and parameters. Such parameters may be tasks to be made, steps, objectives, a mean speed between departure and arrival, a trajectory duration. The trajectory Ta of aircraft A can comprise periods without movement of aircraft A.

An aircraft is a flying transport device capable of moving through the air. By “transport”, it is meant capable of transporting at least one human being or at least one object, for example a camera, a parcel, a processor or any other object. The aircraft A may be an unmanned aircraft, for example a drone, especially a medium-sized drone, or a manned aircraft, for example, but not limited to, a glider, a motorised ultralight glider (also referred to as a “microlight aeroplane”), a helicopter or even a passenger aeroplane, especially a single-engine or twin-engine aeroplane. The aircraft A comprises a processor, for example in an on-board computer, configured to estimate the radial speed Vr of the obstacle O, which will be described in the remainder of the description and/or a method for controlling the aircraft A as a function of the radial speed Vr estimated of the obstacle O, which will also be described in the remainder of the description. The method of the invention is implemented by the processor by executing instructions, stored on a memory, remote or included in the aircraft A. Execution of the instructions by the processor causes the processor to implement the method for controlling aircraft A according to the invention.

An obstacle O to aircraft A is an object located or intended to be located on the trajectory Ta of aircraft A, i.e. the trajectory To of obstacle O intersects the trajectory Ta of the aircraft at a collision point C. When aircraft A is not moving, i.e. when it is static, an obstacle O is an object whose trajectory To passes through aircraft A. An object which never intersects aircraft A may be considered to be an obstacle O by aircraft A if there is a risk of the object colliding with aircraft A. Aircraft A can be configured to consider that each intruder, i.e. each object entering its field of vision, presents a risk of colliding with aircraft A and is therefore an obstacle O.

The purpose of the invention is to estimate the radial speed Vr of the obstacle O relative to the aircraft A. The estimation is performed by computer, preferably a computer on board the aircraft A. The object of the invention is therefore a computer-implemented method. With distance D and radial speed Vr, it is possible to avoid collision between aircraft A and obstacle O by modifying the trajectory Ta of aircraft A using the guidance system.

The radial speed Vr is the speed of the obstacle O projected onto an observation axis of the aircraft A, for example the axis 1 represented in dotted lines in FIG. 1. Aircraft A comprises at least one camera, the function of which is therefore to acquire images. The camera is configured to acquire a plurality of images of the obstacle O. The camera preferably enables images to be acquired at a plurality of different wavelengths, for example in the visible and/or infrared range, preferably in the semi-far infrared and/or far infrared range, so as to enable the radial speed Vr according to the invention to be estimated irrespective of the visibility conditions, and to enable the obstacle O to be detected at night.

Distance D is the distance between aircraft A and obstacle O. The distance D can be obtained, as described in prior art, via an automatic learning method implemented by the aircraft A analysing the images obtained by the camera. The automatic learning method implements a neural network, for example. The distance D is then provided by the automatic learning method at several instants, which may or may not be regular.

The time-to-collision TTC is the time-to-collision between the aircraft A and the obstacle O each following their respective trajectories Ta and To. The time-to-collision TTC can be obtained by image analysis, for example by the variation in apparent pixel size of the obstacle O between images of a sequence of images of the obstacle O obtained by the camera.

To estimate the radial speed Vr, the invention provides the use of an extended Kalman filter, taking as an input the distance D between aircraft A and obstacle O and the time-to-collision of aircraft A with obstacle O. The extended Kalman filter makes it possible to filter the distance and the radial speed Vr, i.e. the estimated distance De and the estimated radial speed Vr are smoothed and less noisy than in prior art. In this way, the distance D input to the extended Kalman filter can be inaccurate while obtaining an estimated radial speed Vr with good performance, i.e. more accurate than in prior art. The extended Kalman filter can handle a measurement space

$$z = [ \begin{matrix}D \\ \frac{1}{TAC}\end{matrix} ]$$

different from the filtering space

$$X = [ \begin{matrix}D \\ Vr\end{matrix} ] .$$

Since the time-to-collision can be obtained as follows:

$$TTC = - \frac{D}{Vr} ,$$

there is non-linearity between the measurement space and the filtering space. The use of an extended Kalman filter makes it possible to manage this non-linearity.

The extended Kalman filter comprises a measurement vector in the measurement space and a state vector in the filtering space. Preferentially, the measurement vector

$$Z = [ \frac{\begin{matrix}D \\ 1\end{matrix}}{TAC} ]$$

comprises the distance D between aircraft A and obstacle O and the inverse of the time-to-collision TTC of aircraft A with obstacle O. The inverse of the time-to-collision TTC avoids filter convergence problems when the obstacle O has a zero radial speed Vr. An obstacle O may have a zero radial speed Vr, for example when the obstacle O is stationary, such as a hot-air balloon. The state vector

$$X = [ \begin{matrix}D \\ Vr\end{matrix} ]$$

comprises the distance D between aircraft A and obstacle O and the radial speed Vr of obstacle O relative to aircraft A.

A Kalman filter operates in two phases: a prediction phase and an estimation phase. The prediction phase uses the state vector Xₖ₋₁ at a preceding state, for example at instant k−1, and seeks to predict the value of the state vector Xx at a current state, for example at current instant k. The estimation phase uses the measurement vector z observed at the current instant k to correct the predicted state xₖ at the current instant k in order to obtain a more accurate prediction.

The operation of the extended Kalman filter according to the invention will now be described.

### Prediction Phase:

The prediction phase starts by calculating the state vector of transition from instant k to instant k+1, for example with an image obtained by the camera at instant k and a second image obtained by the camera at instant k+1, the state vector is then calculated as follows:

$${X}_{k + 1 / k} = F * {X}_{k / k}$$

With

$$F = [ \begin{matrix}1 & dT \\ 0 & 1\end{matrix} ]$$

for constant-speed movement of obstacle O, with dT the time difference between two instants (for example, at 10 Hz, dT=0.1 second).

With

$${X}_{k / k} = [ \begin{matrix}D \\ Vr\end{matrix} ]$$

the state vector estimated at instant k and

$${X}_{k + 1 / k} = [ \begin{matrix}D \\ Vr\end{matrix} ] :$$

state vector predicted at instant k+1 knowing the estimate at current instant k.

To this predicted state vector Xk+1/k corresponds the predicted covariance matrix:

$${P}_{k + 1 / k} = F * {P}_{k / k} + {F}^{T} + Q$$

where P_{k/k} is the

$$[ \begin{matrix}D \\ Vr\end{matrix} ]$$

estimated covariance matrix, P_{(k+1/k)} is the

$$[ \begin{matrix}D \\ Vr\end{matrix} ]$$

predicted covariance matrix, F^{T} is the transpose of F, Q is the modelling matrix for the kinematic regime of the obstacle O. For example, Q can be expressed as follows:

$$Q = {σ}^{2} * [ \begin{matrix}\frac{{dT}^{4}}{4} & \frac{{dT}^{3}}{2} \\ \frac{{dT}^{3}}{2} & {dT}^{2}\end{matrix} ]$$

with σ the acceleration increment expressed in m/s² of the kinematic regime of obstacle O.

### Estimation

In the estimation phase, because the vector of measurements is

$$Z = [ \frac{\begin{matrix}D \\ 1\end{matrix}}{TAC} ] ,$$

the Jacobian H has to be calculated, as follows:

$$H = [ \frac{dZ}{dX} ] = [ \begin{matrix}1 & 0 \\ - \frac{1}{TAC * D} & - \frac{1}{D}\end{matrix} ]$$

With distance D being zero in case of a collision between aircraft A and obstacle O.

Then, the state vector at instant k+1 following the current instant k, comprising the radial speed Vr value and the estimated distance De, is calculated as follows:

$${X}_{k + 1 / k + 1} = {X}_{k + 1 / k} + {K}_{k + 1} * ( {Z}_{k + 1} - h ( {X}_{k + 1 / k} ) )$$

And the covariance matrix associated with the state vector at instant k+1:

$${P}_{k + 1 / k + 1} = ( 1 - {K}_{k + 1} * H ) * {P}_{k + 1 / k}$$

With

$$h ( x ) = [ {X}_{k + 1 / k} ( 1 ) ; - ( \frac{{X}_{k + 1 / k} ( 2 )}{{X}_{k + 1 / k} ( 1 )} ) ] T and {X}_{k + 1 / k} the vector [ \begin{matrix}D \\ Vr\end{matrix} ] .$$

With Kₖ₊₁ the Kalman gain, calculated by taking the Jacobian H and the measurement noises

$$D ( {σ}_{D} ) and \frac{1}{TAC} ( {σ}_{\frac{1}{TAC}} = \frac{{σ}_{TAC}}{{TAC}^{2}} )$$

into account.

The Kalman gain Kₖ₊₁ is obtained by first calculating the matrix S, as follows:

$$S = H * {P}_{k + 1 / k} * {H}^{T} + M$$

with M the

$$[ \frac{\begin{matrix}D \\ 1\end{matrix}}{TAC} ]$$

measurement noise matrix:

$$M = [ \begin{matrix}{σ}_{D}^{2} & 0 \\ 0 & {σ}_{1 / TAC}^{2}\end{matrix} ]$$

where

$${σ}_{D}^{2}$$

is the distance D noise covariacne, and

$${σ}_{D 1 / TAC}^{2} is the \frac{1}{TAC}$$

noise covariance, and noise covariance

$${σ}_{1 / TAC}^{2} = \frac{{σ}_{TAC}^{2}}{{TAC}^{4}} .$$

The Kalman gain is then calculated according to:

$${K}_{k + 1} = {P}_{k + 1 / k} * {H}^{T} * {S}^{- 1}$$

The extended Kalman filter operates with an initial state vector X_{0/0}, i.e. at an initial instant 0. According to the invention, the initial state vector X_{0/0} is initialised as follows:

$${X}_{0 / 0} = [ \frac{\begin{matrix}{D}_{0} \\ - {D}_{0}\end{matrix}}{{TAC}_{0}} ]$$

With D₀ an initial distance corresponding to the first distance obtained by image analysis, and TTC₀ an initial time-to-collision corresponding to the first time-to-collision obtained by image analysis.

The covariance matrix associated with the initial state vector is:

$${P}_{0 / 0} = [ \begin{matrix}{σ}_{D}^{2} & B \\ B & A\end{matrix} ] with \text{:}$$

$$B = - \frac{{σ}_{D}^{2}}{{TAC}_{0}}$$

$$And$$

$$A = \frac{{σ}_{D}^{2}}{{TAC}_{0}^{2}} + \frac{{D}_{0}^{2} * {σ}_{TAC}^{2}}{{TAC}^{4}}$$

The time-to-collision TTC and the distance D are considered to be two decorrelated measurements obtained at the same instant.

Taking the time-to-collision TTC into account as soon as the filter is initialised leads to better convergence of the Kalman filter.

The invention is also directed to an extended Kalman filter for handling cases in which only a time-to-collision TTC measurement has been performed for the current instant k. In such a case, the extended Kalman filter uses the most recent distance measurement D to which it has access, for example because the distance measurements D are stored in a memory, for example the distance measurement D made at the preceding instant k-1, stored in the state vector.

In one embodiment, the radial speed Vr estimation of the obstacle O relative to the aircraft A is performed using a plurality of extended Kalman filters, which can also be considered as a multi-model extended Kalman filter. In this embodiment, a plurality of extended Kalman filters each model a different kinematic regime of obstacle O. By “an extended Kalman filter models a kinematic regime”, it is meant that the extended Kalman filter takes account, in the kinematic regime modelling matrix Q, of a particular kinematic regime of the obstacle O. For example, as represented in FIG. 2, if the plurality of extended Kalman filters comprises three extended Kalman filters, a first extended Kalman filter F1 can model, via the matrix Q1, a kinematic regime corresponding to a non-manoeuvring obstacle O relative to the aircraft A, i.e. an obstacle O which is stationary relative to the aircraft A, a second extended Kalman filter F2 can model, via the matrix Q2, a kinematic regime corresponding to an obstacle O distance-manoeuvring relative to the aircraft A, and a third extended Kalman filter F3 can model, via the matrix Q3, a kinematic regime corresponding to an obstacle O highly distance-manoeuvring relative to the aircraft A, i.e. an obstacle O having numerous movements.

In such a case, i.e. in the multi-model embodiment, each extended Kalman filter takes as an input the same measurement vector

$$Z = [ \frac{\begin{matrix}D \\ 1\end{matrix}}{TAC} ] .$$

This is the case for the three filters F1 to F3 in FIG. 2. Each filter F1 to F3 comprises a kinematic regime modelling matrix Q1 to Q3 respectively, each matrix Q1 to Q3 modelling a kinematic regime of the obstacle O different from the other kinematic regimes. At each instant, each filter F1 to F3 outputs a state vector X1 to X3 respectively for the current instant. Each state vector X1 to X3 comprises an estimation of the radial speed Vr1 to Vr3 of the obstacle O relative to the aircraft A, modelled according to the corresponding kinematic regime in the matrices Q1 to Q3. The state vector X resulting from the multi-model filter is then the barycentre of the state vectors X1 to X3 weighted by a probability of occurrence of the kinematic regime by the obstacle O. The probability associated with each vector X1 to X3 is noted a, b and c respectively. Probabilities a to c are the probabilities that obstacle O will make manoeuvres within the kinematic regime represented by the matrix Q1 to Q3 respectively.

The estimated state vector Xk/k is then the barycentre of the state vectors Xik/k of the filters F1 to F3 weighted by their probability of occurrence Pri:

$$Xk / k = {\sum }_{i = 1}^{3} {X}_{k / k}^{i} * {Pr}_{i}$$

The covariance matrix associated therewith is:

$$Pk / k = {\sum }_{i = 1}^{3} {P}_{k / k}^{i} * {Pr}_{i} + {\sum }_{i = 1}^{3} ( {X}_{k / k} - {X}_{k / k}^{i} ) * {( {X}_{k / k} - {X}_{k / k}^{i} )}^{t} * {Pr}_{i} = {\sum }_{i = 1}^{3} ( {P}_{k / k}^{i} + ( {X}_{k / k} - {X}_{k / k}^{i} ) + {( {X}_{k / k} - {X}_{k / k}^{i} )}^{t} ) * {Pr}_{i}$$

Pri at instant k+1 following the current instant k is updated at each measurement as follows using the probability of occurrence of the same kinematic regime at the current instant k:

$$Pri ( k + 1 ) ∝ Pri ( k ) * {e}^{- \frac{{d}^{2}}{2}}$$

with d2 the normalised innovation of the filter corresponding to the kinematic regime where d²=[(Zk+1−h (Xk+1/k)) T*S−1*((Zk+1−h(Xk+1/k))].

In the multi-model embodiment, the invention allows the different displacement capabilities of obstacle O to be taken into account. The different kinematic regimes can be predicted by configuration, for example stored in a file. The probabilities of occurrence of the kinematic regimes can also be stored in a file. Finally, the kinematic modes can be related to a type of obstacle O. The type of obstacle O can be detected by image analysis, and the different kinematic regimes associated with this type of obstacle O can then be recovered and used in a multi-model Kalman filter, allowing better accuracy of the radial speed Vr.

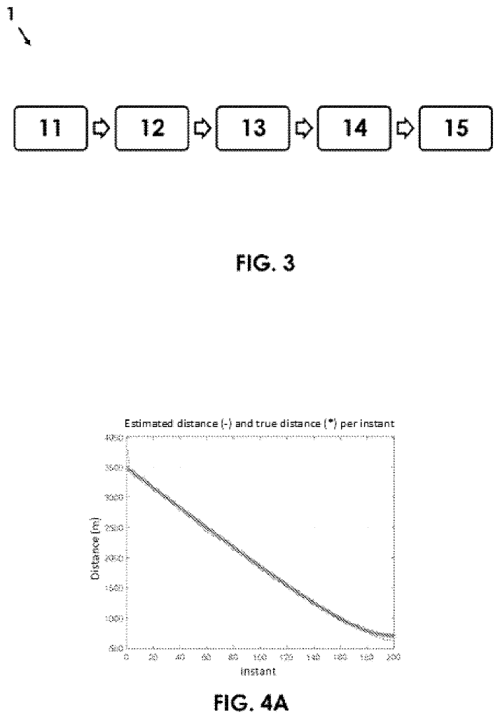

Another aspect of the invention is directed to a method 1 for controlling aircraft A represented in FIG. 3. The method 1 comprises three steps:
A first step 11 of acquiring a distance D between the aircraft A and the obstacle O and a time-to-collision TTC of the aircraft A with the obstacle O from images of the obstacle O obtained by the camera. This step 11 is performed by the camera of aircraft A.
A second step 12 of estimating the radial speed Vr of the obstacle O using an extended Kalman filter taking as an input the distance D between the aircraft A and the obstacle O and the time-to-collision of the aircraft A with the obstacle O, as previously set forth. This estimation is, for example, implemented by a processor included in the aircraft A, from the distance D and the time-to-collision TTC acquired in step 11, input to the single or multi-model extended Kalman filter.
A third step 13 of modifying the trajectory Ta of the aircraft A by the system for guiding the aircraft A, as a function of the radial speed Vr value estimated of the obstacle O and the estimated distance De between the aircraft A and the obstacle O in order to avoid collision of the aircraft A with the obstacle O. The radial speed Vr and the estimated distance De are the information contained in the state vector output from the extended Kalman filter at each instant.

To illustrate gains achieved by the invention in terms of performance on distance D and radial speed Vr, the following table shows a comparison of the invention with a Kalman filter taking distance D alone as an input. Cases 1 and 2 show the results obtained without distance D bias with a distance error of 40% (+/−20% relative to the true distance) by the invention and by a Kalman filter with distance D as an input alone, respectively. Cases 3 and 4 show the results obtained by the invention with a distance D bias of 10% and a distance D error of 20% (+/−10% relative to the true distance) by the invention and by a Kalman filter with distance D as an input alone respectively.

TABLE 1

| | | | | Kalman |
|---|---|---|---|---|
| | Kalman filter | Kalman | Kalman filter | filter ‘D’ |
| | ‘D + TTG’ | filter ‘D’ | ‘D + TTG’ | (Case 4) |
| | (Case 1) | (Case 2) | (Case 3) | Situation: |
| | Situation: | Situation: | Situation: | *10% distance |
| | *No distance bias | *No distance bias | *10% distance bias | bias |
| | *Distance error: | *Distance error: | *Distance error: | *Distance error: |
| | 40% | 40% | 20% | 20% |
| | (±20% | (±20% | (±10% | (±10% |
| | relative to the | relative to the | relative to the | relative to the |
| | true data | true data | true data | true data |
| Estimated | −13.6 ± 139.6 | −12.90 ± 200.7 | −204.28 ± 131.3 | −201.00 ± 140.3 |
| distance error | | | | |
| (m) | | | | |
| % Estimated | 0.12 ± 7.6 | 0.22 ± 10.50 | 10.41 ± 4.5 | 10.25 ± 5.2 |
| distance error | | | | |
| Radial speed | 1.11 ± 12.2 | 29.65 ± 191.8 | 13.11 ± 12.2 | 27.39 ± 90.1 |
| error (m/s) | | | | |
| % Kalman | 0.63 ± 9.4 | 26.58 ± 211.9 | 9.51 ± 8.5 | 31.56 ± 114.2 |
| output radial | | | | |
| speed error | | | | |
| % radial speed | 3.15 ± 20.7 | 3.07 ± 19.9 | 12.90 ± 18.1 | 12.88 ± 17.6 |
| error combining | | | | |
| TTG & AI | | | | |
| distance | | | | |

Table 1 shows that the radial speed errors Vr output from the extended Kalman filter are much lower for cases 1 and 3 than for cases 2 and 4 respectively.

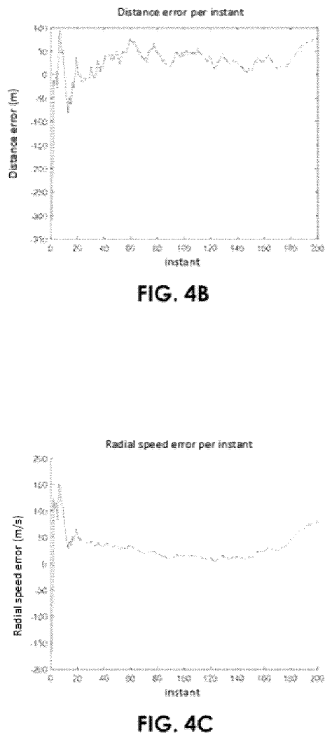

FIGS. 4A, 4B and 4C, 5A, 5B and 5C and 6A, 6B, 6C and 6D show graphs representing metrics relating to the performance of the invention per instant. Each metric is graphically represented per instant, i.e. per image, for example, with instants 0 to 200 corresponding to images 0 to 200 captured by the camera. Alternatively, an instant can be an instant at which a distance is output from the extended Kalman filter.

FIG. 4A, FIG. 4B and FIG. 4C respectively show the estimated distance De in metres, the estimated distance De errors in metres and the radial speed Vr errors in metres per second per instant for an extended Kalman filter modelling a non-manoeuvring kinematic regime of obstacle O with distance D alone included in the measurement vector of the extended Kalman filter.

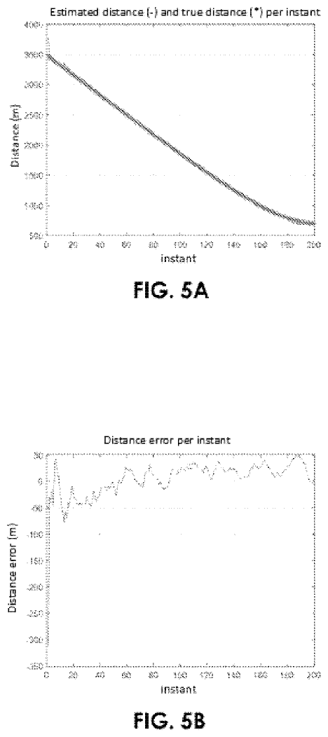

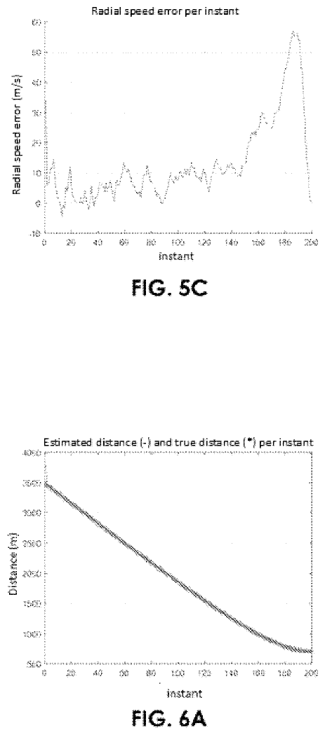

FIG. 5A, FIG. 5B and FIG. 5C respectively show the estimated distance De in metres, the estimated distance De errors in metres and the radial speed Vr errors in metres per second per instant for an extended Kalman filter modelling a non-manoeuvring kinematic regime of obstacle O with distance D and time-to-collision TTC included in the measurement vector of the extended Kalman filter.

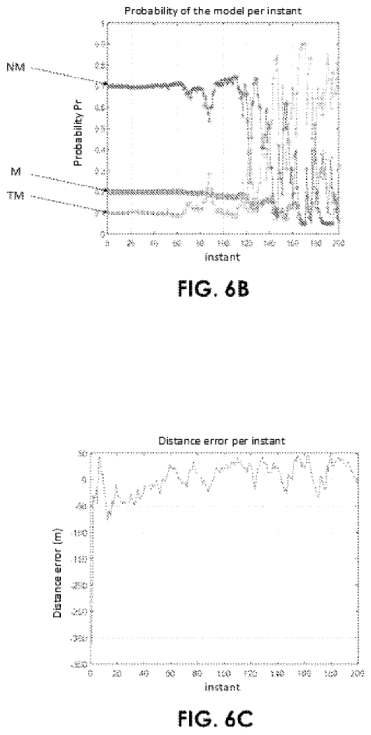

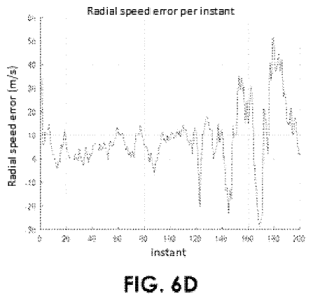

FIG. 6A, FIG. 6B, FIG. 6C and FIG. 6D respectively show the estimated distance De in metres, the probability of occurrence of each model, the estimated distance De errors in metres and the radial speed Vr errors in metres per second per instant for a multi-model extended Kalman filter with distance D and time-to-collision TTC included in the measurement vector of the extended Kalman filter.

The estimated distance De in FIGS. 4A, 5A and 6A is represented by a solid line and the true distance is represented by star-shaped dots.

The probability of occurrence Pr represented in FIG. 6B is represented by pentagon-shaped dots for modelling the highly manoeuvring kinematic regime TM, by round-shaped dots for modelling the manoeuvring kinematic regime M and by star-shaped dots for modelling the non-manoeuvring kinematic regime NM.

1. A method for controlling an aircraft comprising at least one camera and a guidance system configured to indicate a trajectory to the aircraft, the method being computer-implemented and comprising:
acquiring a distance between the aircraft and an obstacle on the trajectory of the aircraft and a time-to-collision of the aircraft with the obstacle from images of the obstacle obtained by the camera,
estimating at least one radial speed of the obstacle using an extended Kalman filter taking as an input said distance and said time-to-collision of the aircraft with the obstacle,
modifying the trajectory of the aircraft by the guidance system, as a function of the radial speed value estimated of the obstacle and the distance between the aircraft and the obstacle so as to avoid collision of the aircraft with the obstacle.

2. The method according to claim 1, wherein the extended Kalman filter comprises a measurement vector and a state vector, the measurement vector comprising the distance between the aircraft and the obstacle and the inverse of the time-to-collision of the aircraft with the obstacle and the state vector comprising the distance between the aircraft and the obstacle and the radial speed of the obstacle relative to the aircraft.

3. The method according to claim 1, wherein the distance of the aircraft from the obstacle is obtained by an automatic learning method based on image analysis, the images having been obtained by a camera on board the aircraft.

4. The method according to claim 1, wherein the time-to-collision of the aircraft with the obstacle is obtained by an automatic learning method based on image analysis, the images having been obtained by a camera on board the aircraft.

5. The method according to claim 1, wherein the radial speed is obtained using a plurality of extended Kalman filters, each extended Kalman filter of the plurality of extended Kalman filters modelling one kinematic regime of the obstacle relative to the aircraft from a plurality of kinematic regimes of the obstacle relative to the aircraft, the kinematic regime modelled by each extended Kalman filter of the plurality of extended Kalman filters being different from the kinematic regime modelled by the other extended Kalman filters of the plurality of extended Kalman filters.

6. The method according to claim 2, wherein each extended Kalman filter of the plurality of extended Kalman filters comprises a state vector representative of the kinematic regime modelled by the extended Kalman filter weighted by a probability of occurrence of the kinematic regime, the radial speed being included in a state vector being the barycentre of the state vectors of the extended Kalman filters of the plurality of extended Kalman filters.

7. An aircraft configured to implement the method according to claim 1, the aircraft comprising at least one camera and a guidance system configured to indicate a trajectory to the aircraft.

8. A non-transitory computer program product comprising instructions which, when the program is executed by a computer, cause the same to implement the control method according to claim 1.

9. A non-transitory computer-readable recording medium comprising instructions which, when executed by a computer, cause the same to implement the control method according to claim 1.
